(19) United States
(12) Patent Application Publication
(10) Pub. No.: US 2008/0120162 A1
(43) Pub. Date: May 22, 2008

(54) System and method for monitoring, recording and reporting the servicing of private onsite wastewater treatment systems

(76) Inventor: Charles Scott Carmody, De Forest, WI (US)

Correspondence Address: BOARDMAN, SUHR, CURRY & FIELD LLP;ATTN: IP PRACTICE GROUP, 1 SOUTH PINCKNEY STREET, FOURTH FLOOR, P.O. BOX 927, MADISON, WI, 53701-0927, US

(21) Appl. No.: 11/903,743

(22) Filed: Sep. 24, 2007

Related U.S. Application Data
(63) Continuation of application No. 09/821,685, filed on Mar. 29, 2001, now abandoned.

(51) Int. Cl. G06F 17/30

(52) U.S. Cl. 705/8

(57) ABSTRACT

A system and method for monitoring, recording, tracking and reporting the inspection, maintenance and servicing of private onsite wastewater treatment systems is disclosed

### FIELD OF THE INVENTION

The present invention relates generally to monitoring, recording and reporting systems and methods. More specifically, it relates to a system and method for monitoring, recording and reporting the inspection, maintenance and servicing of private onsite wastewater treatment systems.

### BACKGROUND OF THE INVENTION

Private onsite wastewater treatment systems (POWTS) are widely used for holding, treating and disposing of wastewater and sewage in areas where access to publicly owned wastewater treatment facilities is unavailable. As used herein, the term private onsite wastewater treatment system means any apparatus or system that is used either for holding waste onsite or for treating and disposing of waste onsite. Onsite means at or near the location where the system is located including neighboring properties. Private onsite wastewater treatment systems include septic systems, seepage beds, seepage trenches, seepages pits, systems-in-fill, mound systems, in-ground pressure systems, holding tanks, pit privies, vault privies, portable toilets, dosing chambers, grease interceptors, experimental systems, and other similar type systems.

Septic systems and holding tanks comprise a majority of POWTS currently in use (although other types of systems, including experimental systems, are also in use). Septic systems typically treat and dispose of waste onsite. Sludge and scum must be pumped from the septic tank from time to time however. Holding tanks, on the other hand, are used solely for storing waste. These tanks must be pumped often. The waste from these tanks as well as from the septic tanks is typically hauled away and discharged into a publicly owned wastewater treatment facility or is spread over agricultural land.

POWTS that are not properly inspected, maintained and serviced can pose serious risks to both public health and to the environment. Waste and sewage, for example, from an improperly maintained system can contaminate groundwater or the lakes and streams in the area of the improperly maintained POWTS. Contamination can also result from run-off when such waste is spread improperly on agricultural land. The magnitude of the problem increases when one considers the sheer number of improperly maintained and serviced POWTS that are presently in existence, especially older POWTS that are in need of service and maintenance.

As a result of public safety and environmental concerns, many states have enacted stringent laws governing the design, installation, inspection, maintenance and servicing of POWTS. These laws can be confusing and complicated, making adherence to them problematic for POWTS owners and service providers who service POWTS.

In addition, the responsibility for carrying out and enforcing these laws typically rests with many different agencies, departments and governmental entities. This diversification of responsibilities can also result in confusion for the service providers and POWTS owners trying to adhere to, and abide by, the law. At the very least, all of this places an undue burden on the service providers and POWTS owners to meet the various requirements placed on them by the laws, regulations and various government entities responsible for regulating POWTS.

An example of the problem is illustrated by FIG. 1 for the state of Wisconsin. It should be noted at the outset that the state of Wisconsin is being used here only for exemplary purposes. The present invention is not limited to use in Wisconsin and is not dependent on any of the laws or regulations of the state of Wisconsin. Rather, the present invention can be used in other states and other jurisdictions as well and can be tailored for use under the laws and regulations of any other state or jurisdiction.

The Wisconsin Department of Commerce (“DOC”) 101 in this state has the responsibility for establishing minimum standards and criteria for the design, installation, inspection and management of POWTS to insure that these systems are safe. The Wisconsin Department of Natural Resources (“DNR”) 102, on the other hand, is responsible for establishing standards for the pumping, hauling and disposal of waste from POWTS. Each of these departments have their own reporting requirements.

DOC regulations, for example, require that a management plan be approved before a permit is issued for any new POWTS or for any modifications to an existing POWTS. Each management plan must include evaluation, monitoring and maintenance schedules for both the overall system and for all of the mechanical components in the system. At a minimum, each management plan must include the following two servicing requirements:

1. The servicing frequency of all anaerobic treatment tanks for POWTS shall occur at least when the combined sludge and scum volume in the tank equals ⅓ of the tank volume; and

2. The servicing frequency of all holding tanks for POWTS shall occur at least when the wastewater of the tank reaches a level that is one foot below the inlet invert of the tank.

For all older POWTS (for which no management plan was required), in addition to the above two requirements, the following two servicing requirements also apply:

3. The servicing or maintenance frequency of POWTS treatment components other than anaerobic tanks and holding tanks shall be provided in accordance with the requirements specified by the manufacturer or designer of the component; and

4. Any POWTS that utilizes a treatment or dispersal component consisting in part of in situ soil shall be visually inspected at least once every 3 years to determine whether wastewater or effluent from the POWTS is ponding on the surface of the ground.

The owner of the POWTS 103 is required by law to submit certain reports 105 to the DOC (“DOC reports”), or its designated agent, relating to the servicing requirements listed above. For example, a DOC report 105 must be submitted upon the completion of each inspection, maintenance or servicing event specified in an approved POWTS management plan. Similarly, the POWTS owner 103 must report the completion of each inspection, maintenance or servicing event identified above in a DOC report 105 in the case of older POWTS for which no management plan was required.

Each DOC report 105 must be submitted to the DOC, or its designated agent, within ten (10) business days from the date of the inspection, maintenance or servicing event and must contain the following information:

1. A POWTS identifying number;

2. The location of the POWTS;

3. The date of inspection, maintenance or servicing

4. The license, certification or registration number of the person performing the inspection, maintenance or servicing; and

5. Any other information required by the approved management plan for the POWTS.

Although the actual obligation for submitting DOC reports to the county lies with the POWTS owner 103, POWTS service providers 107 have typically submitted these reports is on behalf of the POWTS owner as part of the services provided by the service provider.

DOC has designated the counties 104 in the state as its designated agents to receive and process the DOC reports 105 described above. DOC leaves it up to the individual counties, however, to determine the manner and form in which the reports shall be submitted by the POWTS owner. As a result, there is no uniform standard or format for these reports and each county (there are 72 counties in Wisconsin) can dictate there own requirements. At the end of the year, each county 104 is required to provide an annual report 106 (“Annual DOC reports”) to the DOC summarizing the information received in the individual DOC reports 105.

The DNR 101 in Wisconsin requires each service provider to submit or maintain a whole different set of reports from those required by the DOC. In certain cases, the information must be submitted to the DNR on specific forms approved by the DNR. For example, each service provider 107 who disposes of waste by land spreading the waste on agricultural land must submit an “Annual Land Application Report” 108 to the DNR on an approved form. Information to be submitted includes, but is not limited to the following:

1. Completed records of the fields used, gallons and types of waste applied on each field and number of acres used;

2. Crop grown on each field used and its yearly nitrogen requirement;

3. For high use fields, actual annual nitrogen application rate in pounds per acre; and

4. In certain cases, agricultural soil analysis for each high use field once every four (4) years of use.

In addition, each service provider 107 engaged in the disposal of waste other than by land spreading (e.g., by discharge into a publicly owned wastewater treatment facility or into another approved facility operating under a permit to do so) must submit an “Annual Other Method of Disposal or Distribution Report” 109 to the DNR (also on an approved form). Information to be submitted includes, but is not limited to the following:

1. The method of disposal used;

2. The name and permit or license number of the receiving facility, if applicable; and

3. The type and volume of waste disposed.

Each of the above two required reports must be submitted to the DNR by January 31 following the year in which the waste disposal occurs.

Each service provider 107 engaged in the removal and disposal of waste from POWTS in the state must also maintain a daily vehicle log book 110 (or invoice records system) for each service vehicle operated by the service provider. These records must be kept in the vehicle for a minimum of two (2) days after a POWTS system is serviced and thereafter must be kept on file by the service provider for a period of five (5) years. In either case, the daily vehicle log books must be available for inspection by DNR representatives upon request.

The daily vehicle log book 110 for each vehicle must contain at a minimum the following information:

1. Name and address or location of the POWTS system serviced;

2. Date and time of servicing;

3. Type of POWTS system and description of all wastes pumped;

4. Gallons of waste collected;

5. Waste disposal location;

6. Date and time of waste disposal;

7. Written certification (in specific language required by the DNR) by the designated operator-in-charge is regarding the pathogen and vector attraction reduction requirements;

8. A description of how the pathogen reduction requirements are met; and

9. A description of how the vector attraction reduction requirements are met.

As can be seen from the above discussion, a service provider 107 operating in this state has to report their POWTS service related activities to at least two different state agencies 101, 102 and to all of the counties 104 in which the service provider is doing business. Each of these governmental entities requires different information in its reports and the use of different forms.

The reports are due at different times depending on the type of report (e.g., due annually, within ten business days of servicing event, within two days of the servicing event, etc. . . . ). In addition, each county 104 has the added flexibility of adding their own additional reporting requirements.

Each required report to be completed contains a multitude of information some of which is unique to a given report and some of which appears on more than one report. All of these reporting requirements place a heavy burden on the service providers as well as on the counties and government entities collecting and processing these reports.

Currently, there is no simple way to meet all of these reporting requirements. Each individual service provider typically maintains there own individual records and compiles information from those records once a year to complete the required annual DNR reports 108, 109. These reports are typically submitted in paper form to the DNR. The DOC reports 105 are also typically completed and submitted by the service providers to the counties in paper form.

The government agencies are also burdened with paperwork in these cases. The counties 104 for instance must set-up procedures for receiving the DOC reports 105 and must take the information contained in those reports and process it in order for it to be useful. The information must also be compiled into a summary and provided to the DOC at the end of each year in the Annual DOC report 106. The DOC and the DNR in turn typically are left with a stack of completed paper forms to sift through in their effort to monitor and enforce the laws.

Preparing, processing and analyzing all of this paperwork can be burdensome on both the service providers and the interested government agencies that ultimately have to review and analyze the reports. It is desirable therefore to have a system and method for recording and reporting the activities relating to POWTS servicing that is simple and easy to use. Preferably, the system and method will generate and provide reports concerning the service activities of each service provider as well as each POWTS. It is also desirable to have a unified reporting system and method that allows for all of these reports to be prepared, generated, processed, analyzed and viewed using a single system. It is also desirable to have a system and method that allows reports to be prepared, generated, processed, analyzed and viewed in real-time and in electronic form.

It is also desirable to have a system and method that only requires the service provider to enter information (e.g., service report) for each servicing event into the system database one time. Preferably, based on this one time data entry and all of the POWTS permit information (e.g., background information concerning each POWTS) contained in the system database, all of the required reports can be generated.

Identifying POWTS that are not being serviced or maintained properly or that are not in compliance with the laws is also a problem. Generally, for those service events required by law to be performed within a given time period (e.g, every 3 years), interested government agencies have simply sent out notices to POWTS owners reminding them that service needed to be performed within the time period set under the law. This method does not work, however, for servicing requirements for which no time period is specified under the law.

For example, it is difficult for an interested government agency to know when the waste in a particular holding tank is one foot below the inlet invert of the tank. It is even more difficult for an interested government agency to know when a POWTS has not been serviced in accordance with a manufacturer's requirements. As a result, improper servicing and maintenance of these systems can go undetected for months or even years. Letting this type of activity continue can pose a serious threat to both public health and the environment.

It is desirable therefore to have a system and method that can more accurately and reliably identify POWTS that may be in need of inspection, maintenance or servicing. Preferably, the system and method will take into account the different characteristics and features of the various POWTS in identifying those systems requiring service. In other words, the system and method will allow different types of POWTS to be treated differently. Preferably, the system and method will also provide notification to the appropriate governmental agencies of any POWTS that may be in need of service.

Another problem involves identifying POWTS for which no permits were ever issued. Many older POWTS, for instance, may have been installed before permits were required in the given jurisdiction where the POWTS is located. In other situations, it may be that the POWTS owner simply failed to seek a permit. In any event, it has typically been difficult to identify these systems. It is desirable, therefore, to have a system and method that can readily identify installed POWTS for which no permits exist.

Another similar problem relates to identifying service providers who are not in compliance with the law. To do so typically requires that a government official manually review the reports submitted by the service provider and cross reference those reports with the service provider's own service records. This can be time consuming and difficult.

It is desirable, therefore to have a system and method that provides a series of checks and balances between the service provider's records, the service histories for the POWTS and the reports required by the various governmental agencies. Preferably, the system and method will allow all of these items to be integrated into a single system such that each of these items can easily be linked or cross-referenced with each other.

### SUMMARY OF THE PRESENT INVENTION

According to a first aspect of the invention, a method of recording the servicing of private onsite wastewater treatment systems includes receiving service requests for a plurality of private onsite wastewater treatment systems. One of a plurality of service providers is assigned to each of the service requests. Each assigned service provider is notified of each service request assigned to the service provider. A service report is received from each of the assigned service providers describing services performed in response to each service request assigned to the service provider.

Other principal features and advantages of the invention will become apparent to those skilled in the art upon review of the following drawings, the detailed description and the appended claims.

### BRIEF DESCRIPTION OF THE DRAWINGS

FIG. 1 shows a block diagram of the current POWTS service reporting requirements for the State of Wisconsin;

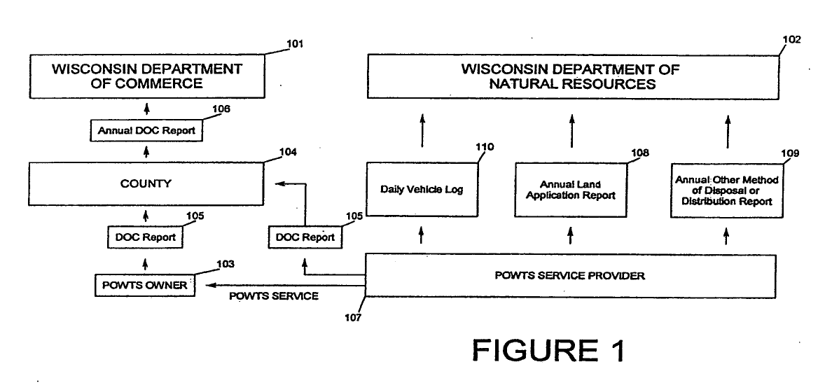

FIG. 2 shows a flow chart of the operation of a first portion of the system according to one embodiment of the present invention;

FIG. 3 shows a flow chart of the operation of a second portion of the system according to the embodiment shown in FIG. 2;

FIG. 4 shows a block diagram of the system reporting capabilities of the system according to one embodiment of the present invention; and

FIG. 5 shows a flow chart of the monitoring capabilities of the system according to one embodiment of the present invention.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to particular systems and methods for monitoring, recording and reporting the inspection, maintenance and service events relating to private onsite wastewater treatment systems, the present invention is not limited to these particular systems or methods and other systems and methods can be used. Similarly, although the present invention will be illustrated with reference to particular system configurations having particular features, other configurations having other features can also be used.

Generally, the present invention involves systems and methods for monitoring, recording tracking and reporting service events relating to private onsite wastewater treatment systems. The methods and systems described herein are not necessarily limited to use with POWTS, however, and can be used in any other application or situation where it is desirable to monitor, record, track and report on service events. As used herein, the term service or service event includes any service related event including inspections, maintenance and repair services, waste pumping, hauling and disposal, etc. . . . Service providers as used herein means any person or entity that services POWTS including waste haulers and plumbers.

In one embodiment of the present invention, a request for POWTS service is received from a POWTS owner. The request is received either by a system operator or by an automatic call center. A service provider is chosen by the owner from a plurality of available service providers and is assigned to the service request. A service provider is assigned to the POWTS for which service has been requested in another embodiment. The assigned service provider is then notified of the pending service request.

The requested service is performed by the assigned service provider Upon completion of the requested service, the service provider completes a single service report describing the services performed. The service event is now complete.

The system now includes sufficient information in this embodiment to generate any necessary reports required by interested government agencies in relation to the service history of the POWTS for which service was performed. Interested government agencies are given access to the information contained in the service request and the service report in one embodiment. In another embodiment, interested government agencies are given access to the required reports. The access is in real-time in another embodiment.

The terms interested governmental agency or entity (also referred to as appropriate governmental agency or entity) as used herein are used in a collective sense to refer to any governmental unit that is involved in regulating the design, installation, inspection, management, or servicing of POWTS and include any federal, state, county, municipal or town agencies or departments.

In another embodiment, a request for POWTS service is received from a POWTS owner. The request is received either by a system operator or by an automatic call center. The request for service triggers a database search of all permitted POWTS (in another embodiment, the database includes all known POWTS including some not having permits) to verify that a valid permit exists for the POWTS requesting service. The appropriate government agency is notified in the event that the POWTS is not found in the permit database in this embodiment. The government agency can then conduct an investigation to determine why the POWTS requesting service was not found in the permit database. In this way, POWTS that are not included in the permit database or POWTS for which no permit exists can easily be identified at the time that service is requested. In alternative embodiments, the database search is triggered by events other than the request for service such as at the completion of service on the POWTS.

In another embodiment of the present invention, the system monitors the service history (service status) of each POWTS (or some of the POWTS) contained in the system's database. Thresholds are set in the system for various servicing events. In other embodiments, other monitoring techniques are used. In one embodiment, for example, time limit thresholds are set relating to when a POWTS should be serviced. POWTS that are not serviced within the time period set for such service are identified by the system (e.g., the threshold for servicing is exceeded). A notification is sent to the appropriate governmental entity identifying the system as having exceeded the threshold. In this way, interested governmental agencies can monitor each POWTS in the systems's database and can follow-up to see if a problem exists when a threshold is exceeded. This monitoring can be done in real-time in one embodiment.

The system in another embodiment is configured to generate one or more reports required by interested governmental entities relating to POWTS servicing events. The system's databases contain all of the information regarding the POWTS service events that is required to generate any of a multiplicity of reports that are required by the various interested government entities charged with regulating POWTS. For instance, in one embodiment, one required report can be generated. In other embodiments, two, three, four, five or more than five required reports, each of which is different from the rest, can be generated by (or from) the system. In addition to required government reports, the system is also configured in other embodiments to provide additional reports that may not be required by interested governmental entities.

In one embodiment, the service provider has access to the system and generates one or more of the required governmental reports. The reports are then submitted to the appropriate government agency by the service provider. The POWTS owner has access to the system and generates the reports for his or her own POWTS in an alternative embodiment. These reports are then submitted to the appropriate government agency by the POWTS owner. In another embodiment, one or more of the various interested government entities have access to the system's databases and can generate the reports on their own. Reports can be generated in real time in another embodiment. In yet another embodiment, the system automatically generates some or all of the required reports. The system automatically submits reports to the appropriate governmental agencies in another embodiment, either in paper (e.g. via facsimile for instance) or electronic form.

Interested governmental agencies, service providers and POWTS owners have access to the system to monitor various POWTS related service events in another embodiment. The access is in real-time in another embodiment. For example, pending service notices or pending work orders that remain open can be accessed by interested governmental agencies. The appropriate governmental agency charged with regulating service providers or POWTS can readily determine which pending service notices have not been completed in a timely manner and can follow-up to determine the cause of the problem. The system also provides information regarding the status of each POWTS, including service history status, that is in the system's databases in another embodiment. Access to this information is in real-time in another embodiment.

The system also allows counties and other interested governmental agencies having access to the system to identify the POWTS permits that were issued during any given period for either the entire state, a county, a town or any other desired political subdivision in another embodiment.

In yet another embodiment, the system databases and the system are accessible by real estate agencies and title companies. These entities typically access the system and databases for the purpose of conducting title searches and/or to generally check on the status and service history of POWTS located on properties that are being offered for sale.

In other embodiments, the system is configured to allow for limitations to be placed on the access provided to any of the parties discussed above. For example, POWTS owners are given access to information regarding only their own POWTS in one embodiment. Access to the system for service providers is limited to information concerning their own servicing activities in another embodiment. Thus, in this embodiment, service providers can access only their own service notices, work orders and reports. Likewise, interested governmental agencies are provided with access to only service information for POWTS located within their jurisdiction in another embodiment.

The system, as mentioned above, includes several databases in one embodiment. These databases make up the overall system database in this embodiment. In other embodiments, more, less or additional databases may be provided. One of the databases provided in this embodiment is the permit database (also called the POWTS database). The permit database contains a record for each of the known POWTS in a given jurisdiction (e.g., country, state, county, township, etc. . . . ). Presumably, each of the POWTS included in the permit database has a valid sanitary permit (or some other type of similar permit) issued for it by the appropriate governmental entity charged with issuing permits for POWTS. However, the permit database includes known POWTS for which no permits exist in other embodiments.

The information contained in each POWTS record in the permit database includes information that is typically required or included in a permit application for a POWTS. The required information can vary from jurisdiction to jurisdiction and the permit database in the present invention can be customized to accommodate these differences. In this embodiment, the record for each POWTS in the permit database includes such information as permit numbers, property location, owner's name, type of building serviced by the POWTS, building use, type of permit, type of system, information about the system, etc. . . . In other embodiments, however, each POWTS record in the permit database includes more, less or additional information.

The permit database is typically updated whenever a new permit is issued for a POWTS by entering the relevant data for the newly issued permit into the system. In other embodiments, the permit database is updated on a scheduled basis (e.g. daily, weekly, monthly, etc. . . . ) or in real-time. This updating can either be done by the appropriate governmental entity that issues POWTS permits (e.g, the governmental entity is given access to the system for the purpose of updating the permit database), by another interested governmental entity or it can be done by the system administrator.

In another embodiment of the present invention, the system is configured to handle and process permit applications. As a result, pending permit applications are also available in the permit database in that embodiment of the present invention, or in some other system database in other embodiments.

The system also includes a POWTS service history database in this embodiment. The service history database includes a service record for each of the POWTS included in the permit database. In an alternative embodiment, only some of the POWTS listed in the permit database have a service history record in the service history database.

The service record for each POWTS includes a complete service history including information regarding the inspection, maintenance and servicing of the POWTS in one embodiment. The service history record includes only pumping history information for each POWTS in another embodiment of the present invention. In alternative embodiments, the service history record for each POWTS is not complete or is complete for some POWTS and not for others.

The service record history database is updated both when a pending service notice is created in the system and when a service report corresponding to the pending service notice is completed and saved to the system by the assigned service provider in one embodiment. In an alternative embodiment, the service history record for each POWTS is updated only when service is completed. Updating of the service history database is done in real-time in another embodiment. In other embodiments, the service history database is updated on a scheduled basis (e.g. daily, weekly, monthly, etc. . . . ).

In addition to the permit database and the service history database, the system in this embodiment also includes a service provider database (also called a carrier database). The service provider database contains information concerning each service provider who is authorized to use the system such as the name, address and telephone number of the service provider, the service provider's license or registration number, information regarding the service vehicles used by the service provider, etc. . . .

This information is typically updated and maintained by the system administrator. In an alternative embodiment, the appropriate governmental entity responsible for regulating and licensing service providers updates the service provider database. Updating of this database typically occurs when a new service provider signs up to use the system or notifies the system administrator of a change in their information. In other embodiments, the service provider database is updated on a scheduled basis (e.g. daily, weekly, monthly, etc. . . . ).

Each service provider authorized to use the system (e.g., authorized service providers) is provided with their own unique service provider web page (e.g., notification site) hosted on the system's web server in one embodiment. The service provider can access their web page using a unique username and password. These web pages are provided to allow a service provider the ability to receive notices regarding pending service requests for POWTS that are assigned to the service provider and to allow the service provider to access pending service notices and work orders directed at the service provider. In other words, by simply logging on to the system and viewing their own web page, each service provider can quickly identify any pending service requests for POWTS assigned to them or for service requests assigned to them.

In an alternative embodiment, each service provider authorized to use the system is provided with a different type of notification site. For example, a service provider may be provided simply with an account where notifications are posted. In other embodiments of the present invention, the service provider provides its own web site or some other site as the notification site for receiving notifications from the system.

Each county (or other interested governmental entity in other embodiments) who subscribes to the system (e.g., subscribing county) in this embodiment is also provided with their own unique web page hosted on the system's web server. Access to each county's web page is also provided via a unique user name and password that are given to each county. The county web pages are primarily provided for two reasons in this embodiment (although there may be other reasons in other embodiments).

The first reason is to allow a county to receive notices regarding potentially un-permitted POWTS located in the county. The second is to allow the county to receive red flags regarding POWTS that may require servicing of some sort (e.g., when a threshold is exceeded). In other words, by simply logging on to the system and viewing their own web page, each county can quickly identify POWTS located in the county for which no permit may exist and can readily identify POWTS that may be in need of immediate servicing. In other embodiments of the present invention, the counties provide their own web site or some other site as the notification site for receiving notifications from the system.

In other embodiments of the present invention, other governmental entities are also provided with their own unique web pages hosted on the system's web server (or some other type of notification site in other embodiments) to allow those entities to receive notices and red flags as well. In yet another embodiment, POWTS owners have access to the system to review information regarding their POWTS such as the permit database record for their system and the service history for their system.

Notification site, as used herein, means a site where notifications, red flags and other information intended only for a particular party (e.g., a particular service provider, a particular interested governmental entity, a POWTS owner, etc.) from the system can be posted or delivered.

The system in one embodiment of the present invention uses a web server hosting a system web site. The web server includes a processor and sufficient memory to host the web site. Some or all of the system databases are also stored in memory on the web server in one embodiment. In other embodiments, the system databases are stored on a separate file server or on some other type of storage device. A call center is provided in another embodiment to receive service requests from POWTS owners. The call center communicates with the web server from client systems located at the call center. Service providers communicate with the web server via client computers remotely located at their locations. In another embodiment, the POWTS owner requests service from the web server by logging directly into the web site from his or her own client computer system. No call center is needed in this embodiment.

Each client computer system includes a processor and sufficient memory to run a web browser in this embodiment. The web browser is used to display the web pages on a display connected to the client computer. The client computer systems in this embodiment communicate with the web server via the Internet.

In another embodiment, the system is not web based. The system runs on a host computer. Users of the system log in to the host computer from remote client computers networked to the host computer. The client computers and the host computer communicate via a local area network (LAN) in one embodiment and via a wide area network (WAN), the Internet or some other type of network in other embodiments.

Each user in this embodiment is provided with a unique username and password. Service providers and interested government entities who use the system are each given an account in this embodiment. Notifications of pending service notices and pending work orders are posted to the accounts of service providers. Likewise, interested governmental agencies receive notices posted to their accounts regarding POWTS that are not listed in the permit database as well as notices concerning POWTS that may require servicing. The service providers and interested government agencies can then view these notices on displays at their client computers by accessing their accounts.

Operation of a monitoring, recording and reporting system encompassing embodiments of the inventions described herein will now be described. The overall system in this embodiment is web based and uses a web site hosted by a web server. The web server can either be located at a call center or it can be located remote from the call center. Authorized users (e.g., service providers, government agencies, POWTS owners, real estate agencies and title companies, POWTS alarm and monitoring manufacturers, etc. . . . ) of the system communicate with the web server from remotely located client computers.

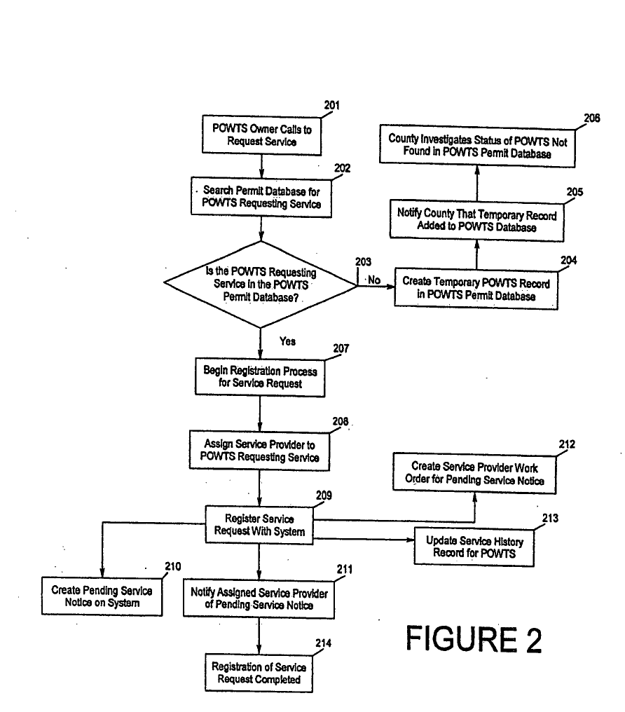

FIG. 2 shows a flow chart for the process of registering a request for service with the system. The process begins in this embodiment when the owner of a POWTS needing service calls a system operator located at a call center to request service for the POWTS (see 201). The system operator logs on to the system's web site using the operator's unique username and password.

In an alternative embodiment, the process is completely automated and no operator is required. The POWTS owner merely calls an automated call center or the web server and is instructed to enter certain requested information on the keypad of the telephone to complete the request for service and register the service request. In another embodiment, the system is voice activated (again no operator is required).

In yet another embodiment, the POWTS owner logs directly on to the system's web site and requests service without the aid of an operator or an automated call center. In yet another embodiment of the present invention, the owner of the POWTS calls an authorized service provider and requests POWTS service directly from the service provider. In this embodiment, the service provider then logs on to the system's web site using the service provider's unique username and password and enters the necessary information to register the request for service with the system as described below.

Once logged on to the system, the system operator searches the POWTS permit database within the system to locate the particular POWTS requesting service (see 202). Searches can be accomplished in this embodiment using various search criteria such as the owner's last name, the owner's telephone number, the permit number of the POWTS, the county name where the POWTS is located, or the address where the POWTS is located. Other search criteria are used in other embodiments.

If the POWTS requesting service is not found in the POWTS permit database (see 203), certain basic information will be requested from the POWTS owner to enable the system operator to establish a temporary POWTS record (also called an incomplete or preliminary record) in the POWTS permit database (see 204). Establishing a temporary record in the POWTS permit database allows the service request to be registered with the system even though no permanent permit record for the POWTS was found.

It should be noted that the temporary record for the POWTS is not a complete permit database record in this embodiment. The temporary record only includes that information necessary to allow the service request to be registered with the system such that the requested service can be carried out. Typical information included in the temporary record in this embodiment includes the owner's name and address, telephone number and the type of POWTS to be serviced. Once all of this information is obtained, the system operator saves the information and a temporary record for the POWTS is created in the POWTS permit database (see 204). In other embodiments, however, a complete POWTS record is created when a request for service is made.

At the time that the temporary record for the POWTS is saved, the system in this embodiment also automatically sends a notification (e.g., red flag) to the county (or other appropriate governmental agency in other embodiments) where the POWTS is located indicating that a temporary POWTS record has been added to the POWTS permit database (see 205). The county where the POWTS is located is notified in this particular embodiment by having the notification (e.g., red flag) automatically appear on the county's own web page hosted on the system's web server. In other embodiments, the county is notified by posting the red flag to a different type of notification site (such as an account) or via electronic mail, telephone, facsimile, regular mail, pagers, etc. . . .

This notification provides notice to the county that a temporary POWTS record has been added to the POWTS permit database for a POWTS that for some unknown reason was not found in the database. Presumably, the POWTS permit database for each county includes all of the POWTS in existence in the county. The fact that this POWTS was not in the POWTS database is an indication that something is amiss.

Red flagging (e.g., notifying the county) of all new POWTS permit database entries at the time that a service request is made (or at the time that the service request is registered) in this manner allows the county to investigate why the POWTS was not listed in the database (see 206). For example, it could be that the system operator simply missed the POWTS in the permit database during the search or it could be that the permit database record for the POWTS in question contains typographical errors that prevented it from being found during the search.

Alternatively, it could be that the subject POWTS changed owners and the permit database records were never updated to reflect the change in ownership. Likewise, it could also be that no permit was ever issued for the subject POWTS. In each of these cases, the notification provided to the county is a tool that enables the county to either update the POWTS permit database to improve its accuracy or to identify POWTS in the county for which no valid permit exists.

Having either located the particular POWTS for which service is requested in the permit database (or alternatively having created a temporary record for the POWTS in the permit database if it was not found), the system operator is now ready to begin registration of the service request in this embodiment (see 207). As part of the registration process, the operator may ask the owner of the POWTS several questions.

One question that is asked in this embodiment, for example, is whether or not the service provider should call the owner before service is performed. In the case of POWTS requiring pumping, the operator in this embodiment will also inquire as to whether this is an emergency pump requiring immediate attention. In other embodiments, other questions may be asked before the request is registered with the recording system.

Another piece of information that is requested at this time in the registration process is the name of the authorized service provider that the owner desires to use. This authorized service provider is then assigned to the POWTS requesting service (see 208). In this way, every POWTS listed in the POWTS permit database is assigned to one authorized service provider from the service provider database (in this way, the POWTS permit database and the service provider database are cross-linked with each other).

In other embodiments, two or more service providers may be assigned to a POWTS (e.g., a primary service provider and a back-up service provider). For example, in one embodiment a first service provider can be assigned for pumping and waste disposal, a second can be assigned for performing inspections and a third can be assigned for performing maintenance or repair. In alternative embodiments, a service provider is assigned to the service request (e.g., not to the POWTS requesting service) or no service providers are assigned to the POWTS requesting service or the service request.

Where the POWTS requesting service has been serviced in the past, the system may already have a service provider assigned to the POWTS (typically the service provider who last serviced the POWTS). For any POWTS with prior service history, the system is configured in this embodiment to remember all of the service providers who have previously serviced the POWTS. POWTS that were not found in the POWTS database and POWTS found in the POWTS database that have no prior service history typically will not, however, have a service provider already assigned in this embodiment.

The owner of the POWTS requesting service can therefore either choose from the list of service providers who have previously serviced the owner's POWTS, if there are any, or the owner can choose from a list of service providers approved to do business in the owner's area. The chosen service provider is then assigned to the POWTS for which service is being requested (see 208).

Once all of the necessary information is obtained from the owner, including the name of the chosen service provider to be assigned, the operator registers the request for service in this embodiment (see 209). Registering the service request with the system does four things in this embodiment.

First, a pending service notice for the requested service is created on the system (see 210). The pending service notice includes information relating to the system to be serviced in this embodiment including the name of the POWTS owner, the permit number for the POWTS, the address for the POWTS and the state, county or township where the POWTS is located. In other embodiments, the pending service notice includes more, less or additional information. In an alternative embodiment, no pending service notices are created by the system when a service request is registered.

Second, the assigned service provider is notified of the pending service notice when a request for service is registered (see 211). In this embodiment, notification of pending service notices is accomplished by displaying a red flashing “Job Waiting” icon on the service provider's own web page hosted on the system's web server. In alternative embodiments, the notification is provided to the service provider via a different type of notification site (e.g, an account) or via electronic mail, telephone, facsimile, regular mail, pagers, etc. . . .

Third, a work order for the pending service notice is created on the system when the service request is registered (see 212). The work order includes information relating to the system to be, serviced in this embodiment including the name, address and telephone number of the POWTS owner, the date and time when the service request was registered and any instructions for the assigned service provider (for example, whether the owner should be called before servicing begins). In other embodiments, the work order includes more, less or additional information. In an alternative embodiment, no work orders are created by the system when a service request is registered.

Finally, the service history record for the POWTS being serviced in the service history database is updated to reflect that service is now pending for the POWTS (see 213). At this point, the registration of the service request with the system is finished and this portion of the overall service event is complete (214).

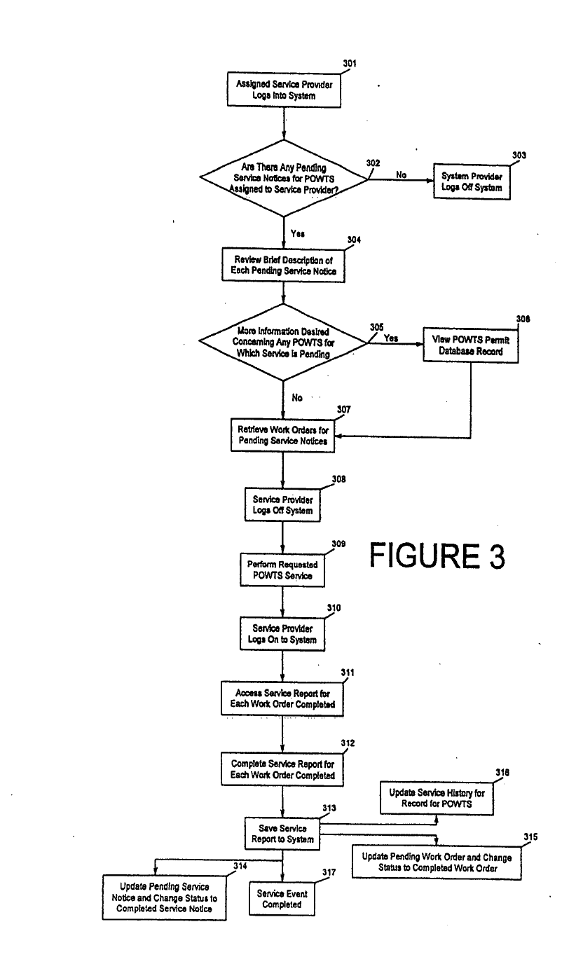

A flow chart for completing the POWTS service event is shown in FIG. 3. Each service provider retrieves their pending service notices for POWTS assigned to them by logging on to the system web site from a client computer remotely located at the service provider's location (see 301). Upon accessing the system web site, the service provider is given access to their own service provider web page hosted by the system web server in this embodiment (each service provider is given their own password protected web site in this embodiment). If there are any pending service notices for the service provider, the red “Job Waiting” icon will be flashing on their web page in this embodiment (see 302).

If there are no pending service requests for POWTS assigned to the service provider (or, in an alternative embodiment, no service requests assigned to the service provider) (see 302), the service provider simply logs off of the system (see 303). When there are pending service notices, however, the service provider can view, the number of pending service notices and a brief description of each pending service notice by clicking on the flashing red icon (see 304). The brief description in this embodiment includes the name address and telephone number of the POWTS owner and the permit number for the POWTS. In other embodiments, more, less or additional information is provided or no brief descriptions are provided.

If the service provider desires more information concerning the POWTS to be serviced (see 305), it can view the full POWTS permit database record for the POWTS by simply double clicking on the brief description of the POWTS appearing on its web page in this embodiment (see 306). This provides the service provider with real-time, on-line access to view the entire permit record for the POWTS to be serviced.

There is a pending work order on the system corresponding to each pending service notice in this embodiment. To view and retrieve the work orders for each of the pending service notices, the service provider simply clicks on the “Work Order” button and a work order for each pending service request is displayed for the service provider (see 307). The service provider then simply prints the work orders to be completed and logs off of the system (see 308).

Once the service provider has retrieved the pending work orders for the POWTS assigned to it, the service provider can proceed to perform the necessary service for each of the POWTS requesting service (see 309). If the owner has asked to be called before service is provided, the service provider calls the owner to set up an appointment for service. If no prior call is required, the service provider merely schedules the service into their schedule. In either case, the requested service is performed and completed by the service provider, including the disposal of any waste that is pumped from the POWTS (see 309).

Upon completion, the service provider logs on to the system again (see 310), this time to complete a service report (also called a waste carriers report in this embodiment) corresponding to each of its assigned POWTS for which service has been completed. Once logged on, the service provider displays all of the pending work orders on the service provider's own system web page. At this point, the service provider simply accesses the service report for each pending work order for which service was performed and completed (see 311).

The service provider then completes a service report for each pending service notice providing information relating to the services rendered (see 312). The service report is completed on-line in this embodiment. In other embodiments the service report is completed off-line and is sent in to the system via electronic mail, regular mail, facsimile or via some other suitable method.

The information to be provided in the service report in this embodiment includes the number of gallons of waste pumped, if any, the date and time the service was performed, the date and time of disposal of the waste from the POWTS, where the waste was disposed, etc. . . . In other embodiments, however, the service report includes more, less, or additional information.

Once the service report is completely filled out (see 312), the service provider saves the report to the system (see 313). At this point, three things happen in the system. First, the pending service notice for the requested service is updated to reflect that service has been completed and its status is changed to completed service notice on the system (see 314). The completed service notice includes information relating to the system to be serviced in this embodiment including the name of the POWTS owner, the permit number for the POWTS, the address for the POWTS and the state, county or township where the POWTS is located. In other embodiments, the completed service notice includes more, less or additional information. In an alternative embodiment, no completed service notices are created by the system when a service event is completed.

Second, the pending work orders are updated to reflect that the work has been completed and their status is also changed to completed work order (see 315). The work orders in this embodiment are updated to include the date and time when the service was completed. Completed work orders remain accessible to the service provider (and others authorized to view them) in this embodiment for 10 days following completion of the services.

Finally, the service history record for the POWTS being serviced in the service history database is again updated to reflect that the service event is now complete and all requested service has been performed (see 316). At this point, the service event for the POWTS is complete (see 317).

It should be noted that completed and pending service notices, POWTS service history records and completed is and pending work orders can be viewed on the system web site in this embodiment by those users who have been given authorization to view such notices, records and orders. In one embodiment, interested government agencies and service providers assigned to the POWTS for which service is either pending or complete are given access. In other embodiments, other parties are also given access to these notices, records and orders including other service providers, call center operators, POWTS owners, real estate agencies and title companies, etc.

It should also be noted that in this embodiment, access to pending and completed service notices, pending and completed work orders and POWTS service history records are in real-time. In other embodiments, access is not provided in real-time. Real-time access, as used herein, means that notices, records, orders, reports, etc. . . . can be viewed as they are entered, changed and updated or substantially at the same time that they are entered, changed or updated.

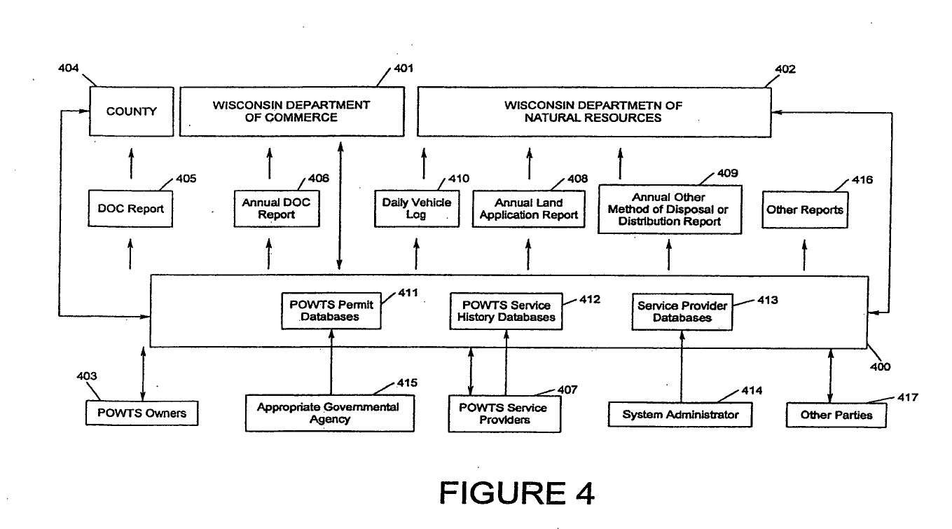

As previously discussed, sufficient information is contained in the system databases in one embodiment of the present invention to enable the system to generate any required government reports regarding the servicing of POWTS and these reports can be generated in real-time. FIG. 4 shows a block diagram illustrating how reports are generated by the system 400 according to this embodiment.

To begin with, the appropriate government agency 415 responsible for issuing POWTS permits is responsible for keeping the POWTS permit database 411 up-to-date in this embodiment. The service history database 412 is updated by the service providers in this embodiment. This occurs every time that a service report for a POWTS is completed and saved on the system by the service provider. In another embodiment, service history database 412 is also updated when service requests are received and registered by system 400. The service provider database 413 is kept current by the system administrator 414 in this embodiment. In other embodiments, databases 411, 412 and 413 are updated by other parties as previously discussed.

The information contained in databases 411, 412 and 413 is sufficient to generate the necessary government reports required by the state of Wisconsin in this embodiment. For example, a service provider 407 authorized to use the system and doing business in Wisconsin can log onto the system and can quickly and easily generate all of the necessary reports required by the DOC 401 (e.g., DOC Report 405) and the DNR 402 (Daily Vehicle Log 410, Annual Land Application Report 408 and the Annual Other Method of Disposal or Distribution Report 409). The system will generate each of these reports for the service provider 407, compiling the necessary information for each report from system databases 411, 412 and 413.

Each of the counties 404, likewise, can log on to the system and can quickly and easily generate the Annual DOC Report 406 to be submitted to the DOC. Again, the system generates this report for the counties 404 by compiling the necessary information from system databases 411, 412 and 413. In the event that other reports 416 are mandated by other interested governmental agencies, those reports can also easily be generated from the system's databases. The only requirement is that the necessary information to complete these other reports is present in one or more of system's databases.

In general, any of the interested government agencies and service providers authorized to use the system can generate and access the required reports in real-time from the system. In other embodiments, POWTS owners 403 are given access and can generate the necessary reports for their POWTS such as DOC Report 405. The POWTS owner 403 can then submit the DOC report 405 to the county without having to rely on the service provider 407 to do so.

Any of the reports generated by the system can also be date limited in one embodiment. For example, if a service history report for a particular POWTS is desired for only a specific year, the system in one embodiment can generate the system history for that POWTS for that year. Likewise, if an interested governmental agency desires to see a required report year-to-date, these types of reports can also be generated by the system in another embodiment.

This type of flexibility can be of great value to interested governmental agencies because they no longer have to wait for year-end annual reports to be submitted. The system in this embodiment provides interested government agencies (and other parties as well) with access to POWTS servicing related information and data throughout the year when it is current. Generally, in various embodiments of the present invention, reports can be date limited to be daily, weekly, monthly, quarterly, year-to-date, etc. . . . In another embodiment, reports can be customized to cover any desired time period.

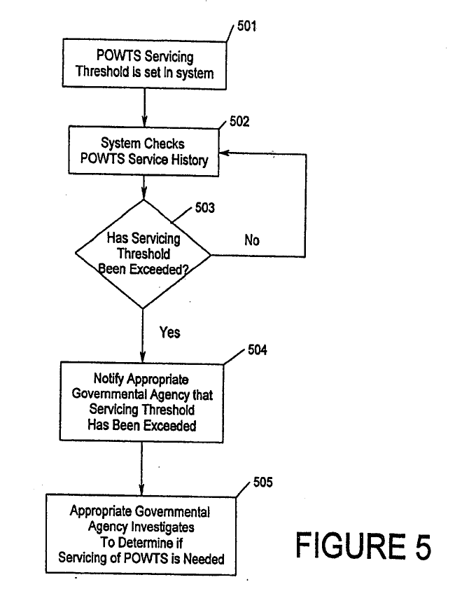

The present invention, as previously mentioned, can also be used to identify POWTS that may be in need of service. As an example (see FIG. 5), a time threshold is set for each type of POWTS and for each type of service to be performed in one embodiment (see 501). For instance, a time threshold of 70 days may be set for pumping holding tanks while a 2 year threshold may be set for inspecting holding tanks. A 3 year threshold is set for pumping septic tanks in another embodiment.

The system in this embodiment automatically monitors the time interval between the last time each holding tank was pumped (this information is contained in the service history record for those POWTS that are identified in the permit database as holding tanks) and the current date (see 502). In the case of the 70 day threshold, if the 70 day threshold is exceeded by any of the holding tank POWTS (see 503), a red flag is sent to the system web page of the county (or to a different notification site in other embodiments) where the holding tank is located notifying the county that the POWTS has not been pumped in the past 70 days (see 504). The county in this embodiment is thus provided with a means by which to identify those POWTS that may require servicing. The county can thereafter investigate to see if servicing of the POWTS is indeed required (see 505). In other embodiments, the notice is sent to the county or other interested governmental agencies via a different type of notification site (e.g., posted to an account) or by other means such as by telephone, electronic mail, facsimile, regular mail, pagers, etc. . . . In yet another embodiment, a notice is automatically sent out to the POWTS owner when the threshold is exceeded.

In one embodiment of the present invention, certain POWTS characteristics and/or features are identified. These characteristics and/or features will typically be identified by the system from the permit database record of each POWTS although they may be found in other system databases in other embodiments as well. Such characteristics and features include the type of system or system components used, size of the system or system components used, age of the system or system components, tank capacity, number of tanks, type of construction, type of materials used in construction, name of the manufacturer of the system or system components, etc. . . . In addition, characteristics of the building or buildings served by the POWTS and site information can also be used including number of buildings served, building size, number of bedrooms, number of rooms, building usage (e.g., residential, commercial, industrial, restaurant, service station, etc. . . . ), building type (single family, multifamily, apartment, hotel), number of units, number of occupants, length of occupancy (year-round, seasonal, occasional occupancy, etc. . . . ), soil type, elevation of site, etc. . . .

Having identified a certain characteristic or feature, POWTS are then classified and sub-classified based on one or more of these identified characteristics and/or features. For example, in one embodiment, all holding tanks are classified into one class and all septic tanks are classified in another class. In another embodiment, holding tanks between 100-500 gallons are classified in one class, holding tanks between 500-1000 gallons are classified in a second class and holding tanks between 1000-1500 gallons are classified in a third class. In yet another embodiment, the above three holding tank classes are further subdivided into subclasses, each subclass defined by the number of bedrooms serviced by the holding tank. In other embodiments, the subclasses are further subdivided.

A threshold is then set or established (e.g, the length of the threshold period) for each class and subclass of POWTS based on the characteristic or feature that defines the class. Or in other words, the length or duration of the threshold period is a function of the characteristics and/or features that define the class or subclass. In this way, each threshold can be customized depending on a system's characteristics and features.

For example, POWTS serving homes that are used year-round probably need to be serviced more often than POWTS serving homes that are only used on a seasonal basis, all else being equal. In this case, therefore, a shorter POWTS servicing threshold (e.g., say 1 year) is established for year-round homes as compared to the POWTS servicing threshold established for seasonal homes (e.g., say 3 years).

As another example, 500 gallon holding tanks probably need to be pumped more often than 1000 gallon holding tanks, again all else being equal. As such the pumping threshold for 500 gallon holding tanks is set at 30 days in one embodiment while the pumping threshold for 1000 gallon holding tanks is set at 60 days.

In yet another embodiment, past service history is used to set future thresholds. For instance, the system is configured to track the service history of POWTS in this embodiment and automatically sets or establishes the duration of future service thresholds based on the past service history. As an example, suppose that a holding tank has previously been pumped once every 30 days. The system in this embodiment automatically checks the service history for the holding tank and sets the pumping threshold at 30 days for this POWTS.

Numerous modifications may be made to the present invention which still fall within the intended scope hereof. Thus, it should be apparent that there has been provided in accordance with the present invention, systems and methods for monitoring, recording, tracking and reporting POWTS service events that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

The embodiments of the invention in which an exclusive property or privilege is claimed are defined as follows:

1. A method of recording the servicing of private onsite wastewater treatment systems comprising:
receiving service requests for a plurality of private onsite wastewater treatment systems;
assigning one of a plurality of service providers to each of the service requests;
for each assigned service provider, notifying the assigned service provider of each service request assigned to the service provider;
from each assigned service provider, receiving a service report describing services performed in response to each service request assigned to the service provider.
